(19) United States
(12) Patent Application Publication
(10) Pub. No.: US 2024/0280805 A1
(43) Pub. Date: Aug. 22, 2024

(54) METHODS AND SYSTEMS FOR MICROSCOPY

(71) Applicant: Applied Materials Israel Ltd., Rehovot (IL)

(72) Inventors: Menachem LAPID, Hashmonaim (IL); Nitzan CHAMIEL, Jerusalem (IL)

(21) Appl. No.: 18/112,876

(22) Filed: Feb. 22, 2023

(51) Int. Cl. G02B 27/00; G02B 13/00; G02B 21/02

(52) U.S. Cl. CPC G02B 27/0025; G02B 13/0095; G02B 21/02

(57) ABSTRACT

The presently disclosed subject matter provides a method for aligning an objective and a pupil relay module of a microscope. The objective is configured to introduce an objective aberration component and the pupil relay module is configured to have a corresponding pupil relay module aberration component such that the pupil relay module aberration component compensates said objective aberration component when the pupil relay module is accurately aligned with the objective. The method comprises: (a) measuring a combined aberration indicator indicative of a combined aberration resulting from the optical combination of the objective and pupil relay module; (b) adjusting an optical alignment of the objective and pupil relay module based on the measured combined aberration indicator; (c) iterating (a) and (b) until the measured combined aberration indicator reaches a predetermined combined aberration indicator target thereby achieving accurate alignment.

### TECHNOLOGICAL FIELD

The present disclosure relates to the field of optical inspection systems such as inspection systems for patterned substrates such as semiconductor wafers and/or masks. More particularly, the present disclosure relates to methods and systems for aligning modules of a modular optical microscope such as an objective and a pupil relay module.

### BACKGROUND

An optical microscope for patterned substrates inspection typically includes a high numerical aperture (NA) objective and a pupil relay module in a folded configuration. The high NA objective may be used to capture high resolution images of a wafer surface. It has a numerical aperture typically greater than 0.7 which allows collecting a high amount light and achieving high resolution. The pupil relay module is typically used to relay an exit pupil of the objective downstream an optical axis thereof, to allow optical manipulation in the exit pupil plane of the objective. The high NA objective and the pupil relay module work together to provide high resolution, accurate images of the substrate.

The alignment of the objective and pupil relay module in an optical microscope is important for accurate and precise sample inspection. If the objective and pupil relay module are not properly aligned, it can lead to several problems, including reduced image quality due to blurriness and distortion, decreased resolution, increased measurement error, and reduced throughput due to longer inspection times. These problems negatively impact the overall quality and efficiency of the inspection process.

### GENERAL DESCRIPTION

In a first aspect, the presently disclosed subject matter provides a method for aligning an objective and a pupil relay module of a microscope. The objective is configured to introduce an objective aberration component and the pupil relay module is configured to have a corresponding pupil relay module aberration component such that the pupil relay module aberration component compensates said objective aberration component when the pupil relay module is accurately aligned with the objective. The method comprises: (a) measuring a combined aberration indicator indicative of a combined aberration resulting from the optical combination of the objective and pupil relay module; (b) adjusting an optical alignment of the objective and pupil relay module based on the measured combined aberration indicator; (c) iterating (a) and (b) until the measured combined aberration indicator reaches a predetermined combined aberration indicator target thereby achieving accurate alignment.

In addition with the above features, the method according to this aspect of the presently disclosed subject matter can optionally comprise one or more of features (i) to
(xvi) below, in any technically possible combination or permutation:
(i) a preliminary step of performing a coarse alignment of the microscope objective with the pupil relay module using an optical jig.
(ii) the coarse alignment includes a movement along three translation axes of the objective in relation to the pupil relay module with a precision of about 10 to 50 micrometers.
(iii) the coarse alignment includes at least one rotation of the pupil relay module in relation to the objective with a precision of about 10 to 50 microradians.
(iv) the coarse alignment includes two rotations (Ox, O_{y}) of the pupil relay module in relation to the objective with a precision of about 10 to 50 microradians.
(v) the objective aberration component substantially is of a single aberration type of an order below a predetermined aberration order threshold.
(vi) the predetermined aberration order threshold is two.
(vii) the objective aberration component comprises primarily of a field dependent aberration.
(viii) the field dependent aberration is field curvature.
(ix) the combined aberration indicator target comprises a combined aberration being below a predetermined threshold of a residual combined aberration of the objective and pupil relay module is smaller than 200 mλ.
(x) the predetermined threshold is smaller than 25 mλ.
(xi) measuring the combined aberration is performed by an imaging technique.
(xii) the objective aberration component is field curvature and measuring the combined aberration indicator comprises assessing image sharpness of a contrast target for light rays in a sagittal plane of the objective, at several locations in a field of view of the objective for various working distances of the contrast target.
(xiii) the objective aberration component is field curvature and measuring the combined aberration indicator comprises assessing image sharpness of a contrast target, separately for light rays in in a tangential plane of the objective, at several locations in a field of view of the objective for various working distances of the contrast target.
(xiv) assessing image sharpness includes measuring a modulation transfer function in in the sagittal plane.
(xv) assessing image sharpness includes measuring a modulation transfer function in in the tangential plane.
(xvi) measuring the combined aberration is performed using a wavefront sensor.

In another aspect, the presently disclosed subject matter provides an optical system for a microscope comprising: an objective; a pupil relay module configured to cooperate with the objective in a folded configuration to relay an image of a sample on a microscope detector, wherein the pupil relay module is configured to be movable with respect to the objective according to six degrees of freedom for aligning the pupil relay module with the objective. The objective is configured to introduce an objective aberration component and the pupil relay module is configured to have a pupil relay module aberration component such that the pupil relay module aberration component compensates said objective aberration component when the pupil relay module is accurately aligned to the objective.

In addition with the above features, the optical system according to this aspect of the presently disclosed subject matter can optionally comprise one or more of features (i) to (vi) below, in any technically possible combination or permutation:
(i) a platform configured for holding a sample and for being translatable relative to the objective along an optical axis thereof at various working distances.
(ii) the objective aberration component and the pupil relay module aberration component are adapted to allow using a null alignment technique.
(iii) said objective aberration component and said pupil relay module aberration component are of a single aberration type and the objective and pupil relay module are configured to minimize optical aberrations expect for said aberration type.
(iv) said aberration type is field curvature.
(v) the objective aberration component is in a range amount of 250 to 5000 mλ.
(vi) the objective aberration component is in a range amount of about 1000 to 3000 ma.

In another aspect, the present disclosure provides a microscope for semiconductor inspection tool including an optical system as described above.

In another aspect, the presently disclosed subject matter provides a method of designing an optical microscope comprising: providing an objective having an embedded exit pupil; and providing a pupil relay module for cooperating with the objective in a folded configuration, the pupil relay module being configured for imaging the embedded exit pupil downstream of the objective on an optical axis thereof, wherein the pupil relay module is configured to be movable with respect to the objective according to six degrees of freedom for aligning the pupil relay module with the objective. The method further comprises: introducing into the objective an objective aberration component; and introducing into the pupil relay module a pupil relay module aberration component such that the pupil relay module aberration component compensates said objective aberration component when the pupil relay module is accurately aligned with the objective. The objective aberration component and the pupil relay module aberration component are adapted to allow using a null alignment technique.

In addition with the above features, the method according to this aspect of the presently disclosed subject matter can optionally comprise one or more of features (i) to (vi) below, in any technically possible combination or permutation:
(i) the objective aberration component and the pupil relay module aberration component are adapted to allow using a null alignment technique.
(ii) the objective aberration component is in a range of 250 to 5000 mλ.
(iii) the objective aberration component is in an amount of 1000 to 3000 mλ.
(iv) the objective aberration component is in an amount of about 1400 mλ.
(v) said objective aberration component and said pupil relay module aberration component are of a single aberration type and the objective and pupil relay module are configured to minimize optical aberrations expect for said aberration type.
(vi) said aberration type is field curvature.
(vii) other optical aberrations than the objective aberration component in the objective and the pupil aberration component in the pupil relay module are smaller than 50 m).
(viii) a residual combined aberration of the objective and pupil relay module when accurately aligned is smaller than 25 mλ.

In the present disclosure, the following terms and their derivatives may be understood in view of the following explanations:

The term “optical aberration” or “aberration” may refer to imperfections in the imaging performance of an optical system such as a microscope. Aberrations may be caused by the deviation of the system from the ideal behavior of a perfect optical system. There are typically several types of optical aberrations, including:
Chromatic aberrations which occur when light of different wavelengths is not brought to the same focus. This can cause a rainbow-like effect around the edges of an image.
Spherical aberrations which occur when light is not brought to a single point focus. This can cause a softening of the image and a loss of resolution.
Coma aberrations which occur when light coming from off-axis points is not brought to a single point focus. This can cause a comet-like shape to appear in the image.
Astigmatism which occurs when light is focused differently in two perpendicular planes. This can cause an image to appear distorted.
Distortion which is caused by the deviation of the image from the ideal geometric shape, like a straight line appearing curved.
Curvature of field (or field curvature) which is caused by the deviation of a sharpest image plane from a flat surface.
It is noteworthy that in the present application, the values for optical aberrations may be expressed as peak to valley values (P2V).

The term “combined aberration” of an optical system made of several modules may refer to the overall imperfections in the imaging performance of the system that result from the combined effects of all of the individual modules. Each module in an optical system, such as a objective or a pupil relay module of a microscope, may have its own aberrations, and these aberrations may add together when the system is composed of multiple modules.

The term “aberration measurement” may refer to a process for quantifying imperfections in the imaging performance of an optical system. This may be done by measuring the deviation of the system's performance from the ideal behavior of a corresponding perfect optical system. There are various methods to measure the aberrations of an optical system such as interferometry, wavefront sensing or imaging techniques. Interferometry is a technique that uses the interference of light to measure the wavefront of light passing through an optical system. Wavefront sensing for example by using a Shack-Hartmann wavefront sensor measures the deviation of the wavefront of light passing through the optical system. When using a wavefront sensor, one method is to use a technique called Zernike polynomial decomposition. This technique separates the wavefront into different components. Imaging techniques include image analysis/processing methods of an image of an object with a known shape and size (e.g. a test chart with lines, a point source, etc.) imaged through the optical system for example to obtain a Point Spread Function (PSF) measurement, an Edge Spread Function (ESF) measurement, a Line Spread Function (LSF) or a Modulation Transfer Function (MTF) measurement.

The term “Point Spread Function” (PSF) may refer to a function that describes the pattern of light created by a point source of light after passing through the optical system. The PSF is typically represented as a two-dimensional image, with the intensity of the light at each point in the image representing the amount of light present at that point in the image. The PSF can be measured experimentally by imaging a point source of light and analyzing the intensity profile of the point in the image. By analyzing the PSF, it is possible to detect and quantify various types of aberrations that can affect the image quality of an optical system.

The term “Edge Spread Function” (ESF) may refer to a measure of the sharpness of the edge of an object in an image. The ESF may be obtained by measuring the width of the edge of an object in the image and comparing it to the width of the same edge in the object plane. This measurement is typically expressed as a percentage of the width of the edge in the object plane, it indicates the degree of blurring of the edge in the image. The ESF can be used to quantify the aberrations in the optical system, by comparing the measured ESF with a theoretical ESF of an aberration-free system.

The term “Modulation Transfer Function” (MTF) may refer to a description of how the contrast of the image changes as a function of spatial frequency. The MTF can be measured experimentally by imaging a test pattern with varying spatial frequencies and analyzing the contrast of the image at each frequency. The MTF can be used for aberration measurement by analyzing how the contrast of the image changes as the spatial frequency of the test pattern increases. It is noteworthy that the ESF enable obtaining a LSF which is a PSF in one dimension while the PSF is in two dimensions. Further, the LSF can be obtained from the PSF by integrating along one dimension the PSF and that by further processing the LSF using Fast Fourier Transform, it is possible to obtain the one dimensional MTF.

The term “optical jig” may refer to a mechanical device that allows for precise alignment of optical components, such as the objective and the pupil relay module by holding them in a specific position and orientation. The jig can have micrometer adjustment to move the component around to align it to the desired position. The jig can be used to align the optical components in a specific position and orientation.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 illustrates a microscope according to embodiments of the present disclosure;

FIG. 2 shows a box diagram illustrating steps of a method for aligning an objective and a pupil relay module according to embodiments of the present disclosure;

FIGS. 3A-3B illustrate additional details of a method for aligning an objective and a pupil relay module according to embodiments of the present disclosure;

FIG. 4A-4B illustrate additional details of a method for aligning an objective and a pupil relay module according to embodiments of the present disclosure.

FIG. 5A-5E illustrate simulation results of a method for aligning an objective and a pupil relay module according to embodiments of the present disclosure.

### DETAILED DESCRIPTION OF EMBODIMENTS

In the following detailed description, numerous specific details are set forth in order to provide a thorough understanding of the invention. However, it will be understood by those skilled in the art that the presently disclosed subject matter may be practiced without these specific details. In other instances, well-known methods, procedures, components and circuits have not been described in detail so as not to obscure the presently disclosed subject matter.

Unless specifically stated otherwise, as apparent from the following discussions, it is appreciated that throughout the specification discussions utilizing terms such as “measuring”, “adjusting”, “comparing”, or the like, may refer to the action(s) and/or process(es) of a computer that manipulate and/or transform data into other data, said data represented as physical, such as electronic, quantities and/or said data representing the physical objects. The term “computer” should be expansively construed to cover any kind of hardware-based electronic device with data processing capabilities including, by way of non-limiting example, FPEI system and respective parts thereof disclosed in the present application.

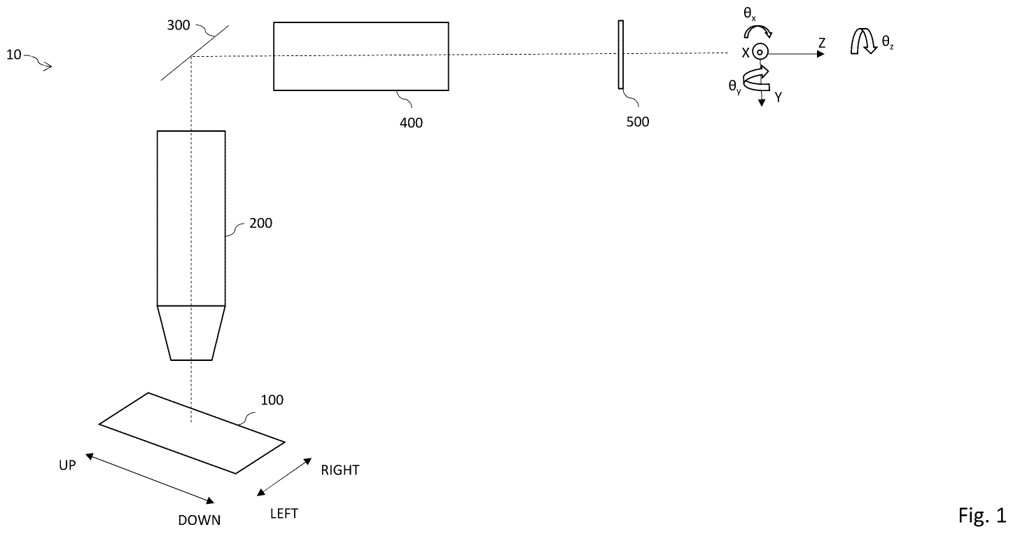

FIG. 1 depicts an optical microscope 10 for patterned substrates (wafer and/or masks) inspection according to embodiments of the present disclosure. The microscope 10 may include a stage 100, an objective 200, a mirror 300 (or other means) for folding an optical axis of the objective 200, a pupil relay module 400 and a detector 500.

The stage 100 may be configured for holding a specimen such as a wafer in place during inspection. The stage 100 may be configured to allow for precise movement of the wafer in the Up-Down/Left-Right plane, allowing for scanning of the entire wafer surface for example by including a mechanism such as a motorized linear stage. The stage 100 may be configured to allow for Z-axis motion for focusing the objective 200 on the wafer surface, where Z represents the optical axis of the objective 200. The stage 100 may also include a mechanism for moving the wafer in the Z-axis direction, such as a motorized linear stage, which allows for precise and accurate focus of the objective 200 on the wafer.

In some embodiments, the stage 100 can also have a mechanism for controlling the environment around the wafer, such as a gas flow or vacuum system, to protect the wafer from dust or other contaminants during inspection. The stage 100 may be designed to be compatible with different wafer sizes and shapes, such as round or square wafers, and can be easily changed to accommodate different types of wafers.

The stage 100 may include a specimen positioning mechanism for measuring the specimen's position and alignment with respect to the optical axis Z of the microscope, such as a laser interferometer or a vision system to ensure that the specimen is properly positioned and aligned before inspection. The laser interferometer may enable projecting a laser beam onto the specimen, and then measuring the interference pattern that is created as the beam reflects off the surface of the specimen. By analyzing the interference pattern, the interferometer can determine the position and alignment of the specimen with high precision. The vision system may include a camera to capture an image of the specimen, and then use image processing techniques to analyze the image and determine the position and alignment of the specimen.

The objective 200 may magnify an image of the specimen. The objective 200 may form a separate module of the microscope 10. The objective 200 may be positioned vertically above the stage 100. In some embodiments, the objective 200 may be fixed relative to a housing of the microscope 10 (not shown). The objective 200 may be designed to have high numerical apertures (NA) which allows for a high resolution, and a large depth of field. This allows for a larger portion of the specimen to be in focus at the same time. The objective 200 may include a front lens element configured to gather light from the sample and direct it into the objective. The objective 200 may further include an aperture stop such as a circular diaphragm configured to control the amount of light entering into the objective. The objective may also include additional lens elements typically located between the front lens element and the aperture stop. The objective lenses may be coated with different materials like anti-reflection, or multi-layer coatings to improve the transmission of light through the lens and reduce the loss of light caused by reflections. The objective 200 may have its exit pupil is positioned inside the objective. This may allow for a more efficient use of light and for a more compact design. The objective 200 may be telecentric. Telecentricity may enable the objective to maintain a constant magnification and/or a constant light matter behavior along the FOV.

The objective 200 may be configured to introduce an objective aberration component The objective aberration component may be adapted to allow alignment with the pupil relay module 400 using a null alignment technique. The objective aberration component may be in a range of 250 to 5000 mλ peak to valley, preferably of about 1400 mλ. The objective aberration component may substantially consist of optical aberrations of the second order. In some embodiments, the objective aberration component comprises primarily (i.e. consists substantially) of a field dependent aberration, for example field curvature.

The mirror 300 may be positioned above the objective 200. The mirror 300 is used to fold the optical axis and direct the light onto the pupil relay module 400. The folding of the optical path may enable to make the microscope more compact.

The pupil relay module 400 may include one or more lenses and/or mirrors configured to redirect the light exiting the objective. The pupil relay module 400 may be mechanically separable from the microscope. The pupil relay module 400 may be configured for imaging the objective exit pupil downstream of the objective on an optical axis thereof. The pupil relay module may be configured to be adjustable with respect to the objective according to six degrees of freedom for aligning the pupil relay module with the objective. The six degrees of freedom may include: movement along three translation axes X, Y, Z with respect to the objective 200 and three rotations θₓ, θ_{y}, θ_{z} around said three translation axes. The movability in six degrees of freedom may be achieved for example by using micrometer screws, piezoelectric actuators or other types of actuators. It is noteworthy that the working distance (i.e. a seventh degree of freedom of the system) may also be calibrated using the presently disclosed method.

The pupil relay may have a pupil relay module aberration component such that the pupil relay module aberration component compensates said objective aberration component when the pupil relay module is aligned with the objective. In some embodiments, a residual combined aberration of the objective and pupil relay module when accurately aligned is smaller than 200 mλ, for example 25 mλ.

The objective aberration component and correspondingly the pupil relay module aberration component may be of a single aberration type, for example field curvature. The amount of objective aberration component and correspondingly the pupil relay module aberration component may be adapted for performing efficiently a null alignment method i.e. in a range enabling sensitivity to misalignment and avoiding that environmental variations such as temperature variations or mechanical turbulences impact too strongly the image quality. The Applicant has found that the objective aberration component may preferably be in a range of 250 to 5000 mλ, 1000 to 2000 mλ, or preferably around 1400 mλ. It is noteworthy that optical aberrations other than the objective aberration component in the objective and the pupil relay module aberration component in the pupil relay module are configured to have a low level, for example to be smaller than 50 mλ. In other words, the level of other optical aberrations is less than 10 times the level of the objective/pupil relay module aberration component i.e. a distribution of aberrations per aberration type in the objective and pupil relay module forms a peak. In other words, the objective and respectively the pupil relay module may be configured to minimize optical aberrations except for the objective aberration component, respectively the pupil relay module aberration component.

The detector 500 may be configured to capture an image formed by the objective 200 and pupil relay module 400. The detector 500 may convert the image into an electrical signal that can be processed electronically by a microscope electronic control unit (not shown). The electronic control unit may be configured to control the various functions of the microscope, such as adjusting the focus, aperture, and magnification, as well as processing the image data captured by the detector. The electronic control unit may include a processor, memory and input/output interfaces which receive commands and sends signals to other components of the microscope.

The microscope 10 may further include an optical jig enabling coarse mechanical alignment of the objective 200 and pupil relay module 400. The optical jig is typically designed to hold the objective and the pupil relay module in a fixed position and orientation, with the ability to adjust the position and orientation of the pupil relay module. This can be done by using micrometer screws, linear stages, or other types of actuators, which can be controlled by the electronic control unit of the microscope. The optical jig may enable alignment of the objective 200 with respect to the pupil relay module 400 along the three translation axes with a precision of less than 10 micrometer, for example about 5 micrometers. The optical jig may also enable alignment of the objective with respect to the pupil relay module for the two sagittal rotations (θₓ, θ_{y}) with a precision of up to tens of microradian, for example 10 to 50 microradians, for another example 25 microradians.

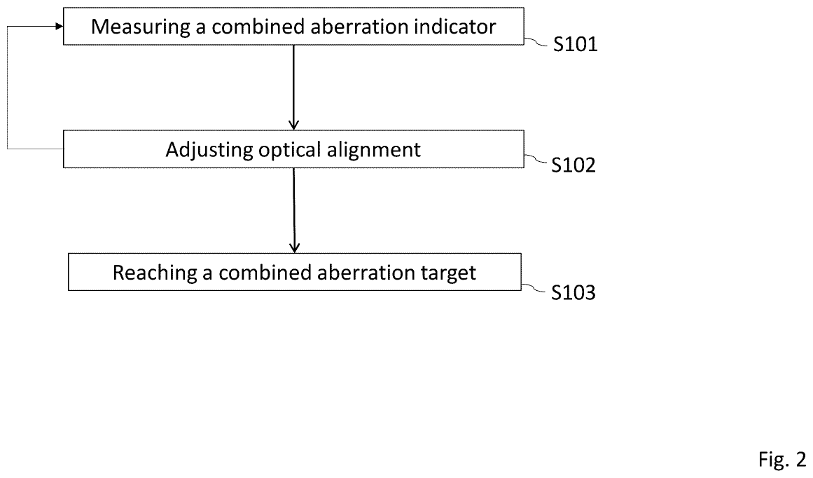

FIG. 2 illustrates a null alignment method for aligning an objective and pupil relay module of the microscope described hereinabove according to embodiments of the present disclosure.

In an optional preliminary step (not shown), the method may include performing a coarse alignment of the microscope objective with the pupil relay module using the optical jig. The microscope objective may be fixed relative to the housing of the microscope and the coarse alignment of the microscope objective with the pupil relay module may include adjusting a position and orientation of the pupil relay module relative to the objective. The coarse alignment may provide an alignment along three translation axes of the pupil relay module relative to the objective with a precision of about a micrometer. The coarse alignment may provide alignment of the pupil relay module relative to the objective according to two sagittal rotations θₓ, θ_{y} with a precision of about 10 to 50 microradians. The following steps may enable to fine align pupil relay module and objective. In particular, the method may enable to accurately align a tilt rotation θ_{z} of the pupil relay module around the optical axis Z.

In a step S101, the method may include measuring a combined aberration indicator indicative of an optical aberration resulting from the optical combination of the objective and pupil relay module (also referred to as “combined aberration”). Several techniques may be employed to measure the combined aberration indicator resulting from the optical combination of the objective and pupil relay module.

In some embodiments, the combined aberration indicator may be the combined aberration itself and measuring the combined aberration indicator may be performed by measuring optical aberrations resulting from the combination of the objective and pupil relay module by using a wavefront sensor. The wavefront sensor may be a Shack-Hartmann sensor configured to measure the wavefront of the light passing through the objective and the pupil relay module. The wavefront sensor may analyze the wavefront and calculate the combined aberration introduced by the objective and the pupil relay module. In other embodiments, the optical aberrations may be measured using an interferometer.

In some embodiments, the combined aberration may be measured by imaging techniques. Imaging techniques may include assessing one or more image quality metrics such as a Strehl ratio, a modulation transfer function, an edge transfer function and/or a point spread function to evaluate the performance of the system and compute said combined aberration indicator. Imaging techniques may enable avoiding implementation of costly wavefront sensors or interferometers within inspection tools embedding the microscope. Further, imaging techniques may eliminate a requirement for opening said inspection tools and therefore avoid deterioration of the optical properties of the microscope. In some embodiments, the objective aberration component (and correspondingly the pupil relay module aberration component) substantially is of a single field dependent aberration type, for example field curvature. The Applicant has found that when the objective aberration component is field curvature, alignment of the objective and pupil relay module can advantageously be simplified. When the objective aberration component is field curvature, measuring of the combined aberration indicator may comprise assessing image sharpness of a contrast target, separately for light rays in a sagittal plane and for light rays in a tangential plane of the objective, at several locations in a periphery of a field of view of the objective for various axial positions of the contrast target (also referred to as working distance i.e. the distance between the objective and the sample on the microscope stage). The contrast target may be an edge contrast target. In some embodiments the several locations in the periphery of the field of view may include mainly locations at opposite edges of the field of view along the direction of the corresponding lights rays, i.e. a left edge and a right edge for tangential rays and an upper edge and a lower edge for sagittal rays.

In other words, measuring of the combined aberration indicator may comprise assessing an astigmatism over the field resulting from the unaligned optical combination of the objective and pupil relay module. In some embodiments, measuring of the combined aberration indicator may additionally include measuring an astigmatism resulting from the unaligned optical combination of the objective and pupil relay module at one or more location in a central portion of the field of view of the objective for various axial positions of the contrast target. Measuring said astigmatism may comprise assessing image sharpness of said edge contrast target for light rays in a sagittal plane and for light rays in a tangential plane.

Assessing image sharpness may include computing a tangential modulation transfer function and a sagittal modulation transfer function. Measuring the astigmatism at several locations in the periphery of the field of view may enable to detect when field curvature is compensated. Indeed, obtaining a sharpest image at different axial positions of the target for the several locations in the field of view, may be indicative that field curvature aberration is not completely compensated and that the alignment is therefore not accurate and needs adjustment. Furthermore, assessing separately the image sharpness for light rays in a sagittal plane and for light rays in a tangential plane may facilitate identifying which movement (in particular, which rotational adjustment) of the pupil relay module may be needed in order to improve alignment of the pupil relay module and objective.

In a further step S102, the method may include adjusting the optical alignment of the objective and pupil relay module based on the measured combined aberration indicator. The measured combined aberration indicator may preferably enable to facilitate deciding which rotational adjustment is to be performed. In embodiments in which the objective aberration component is field curvature and the measuring of the combined aberration indicator involves assessing image sharpness of a contrast target, separately for light rays in a sagittal plane and for light rays in a tangential plane of the objective, at several locations in a periphery of a field of view of the objective for various axial positions of the contrast target, adjusting the optical alignment may include adjusting a rotational position (according to a rotational axis) of the pupil relay module when obtaining a sharpest image at different (i.e. distant) axial positions of the target for the several locations in the field of view of the light rays in the sagittal plane and adjusting another rotational position (according to another rotational axis) of the pupil relay module when obtaining a sharpest image at different (i.e. distant) axial positions of the target for the several locations in the field of view of the light rays in the tangential plane.

In a further step S103 the method may include iterating steps S101 and S102 until the measured combined aberration or measured combined aberration indicator reaches a predetermined combined aberration indicator target. In some embodiments, the combined aberration indicator target may comprise a residual combined aberration being below a predetermined threshold. The predetermined threshold of the residual combined aberration of the objective and pupil relay module may be smaller than 200 mλ, preferably smaller than 25 mλ. In some embodiments, reaching the combined aberration indicator target may comprise qualitatively reaching an optimal adjustment i.e. where no further improvement can be achieved.

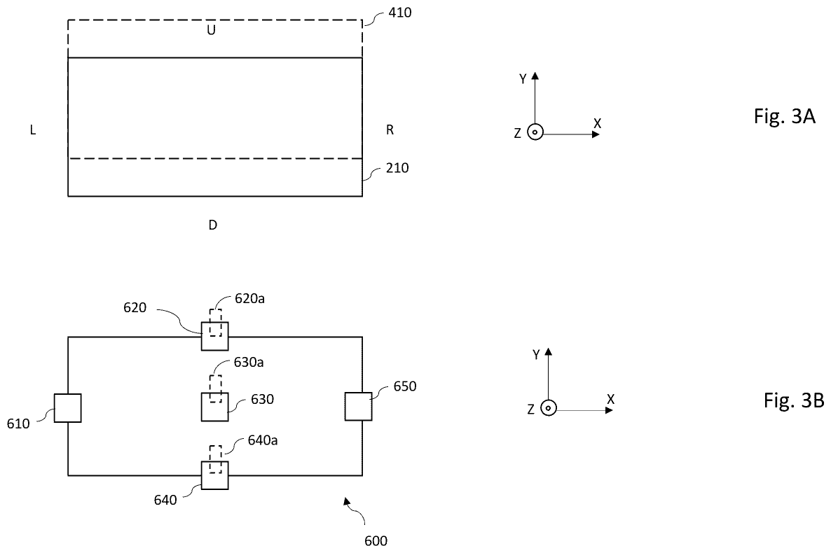

FIGS. 3A-3B illustrate additional details of a method for aligning an objective and a pupil relay module according to embodiments of the present disclosure. FIGS. 3A-3B show a misalignment of the pupil relay module according to a pitch rotation (also referred to as tilt or X-tilt) about the X axis.

As shown in FIG. 3A, the misalignment of the pupil relay module according to the pitch rotation translates in an output angular field of view 410 of the pupil relay module being shifted from an input angular field of view 210 of the objective. As illustrated in FIG. 3B and detailed herein above, the presently disclosed method may include assessing an image sharpness in the tangential direction (i.e. for light rays in a tangential plane of the objective) at several locations in the field of view of the objective. This may be achieved by positioning edge targets 620, 630, 640 at said different locations within the field of view of the objective. The edge targets may be imaged such that a transition between light and dark occurs perpendicular to the tangential direction. Imaging areas 620a, 630a and 640a illustrate areas such that the transition occurs perpendicular to the tangential direction. Further, the edge targets 620, 630, 640 may be positioned vertically (i.e. such as to scan the field of view in a direction perpendicular to the tangential direction). As illustrated, two or more locations within the field of view may be imaged such as to easily detect a variation over the field of view of a working distance corresponding to a sharpest image. Advantageously, a contrast target may be positioned in the center of the field of view.

For each working distance, the image of the edge targets 620, 630, 640 over imaging areas 620a, 630a, 640a may be analyzed to determine an edge spread function (ESF) and a tangential MTF (MTFT) over said respective image areas. The MTFT may be averaged over relevant spatial frequencies.

The resulting MTFT corresponding to a target may provide an assessment of image sharpness for various working distances, enabling to determine a working distance for a sharpest image. By comparing the working distances of the sharpest image for said several locations over the field of view, it is possible to detect a remaining field curvature aberration resulting form the optical combination of the pupil relay module and objective. This is because in the absence of field curvature aberration, the working distance for the sharpest image at different location in the field of view should be the same. Furthermore, an adjustment to act on the remaining aberration detected by the assessment of the image sharpness in the tangential direction may be performed by modifying the pitch rotation angle of the pupil relay module.

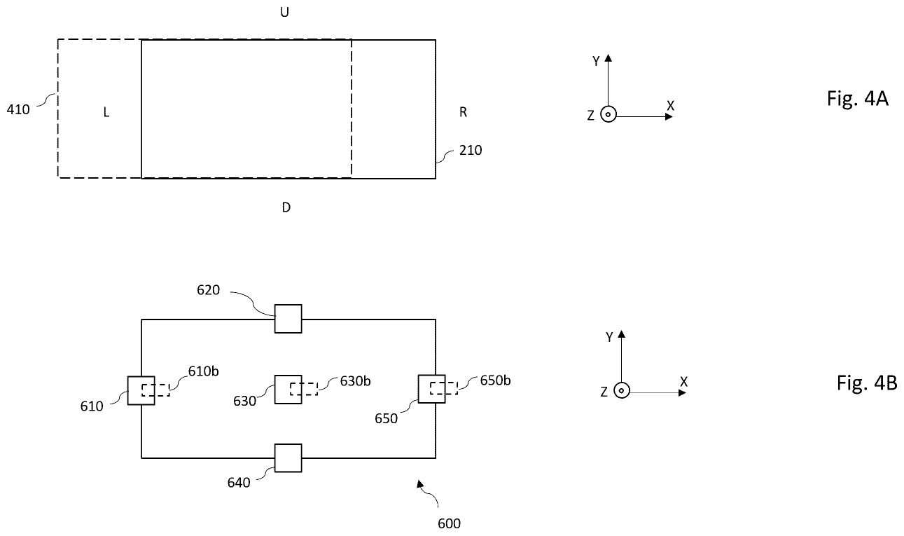

FIGS. 4A-4B illustrate additional details of a method for aligning an objective and a pupil relay module according to embodiments of the present disclosure. FIG. 4A-4B show a misalignment of the pupil relay module according to a yaw rotation (also referred as tilt or Y-tilt) about the Y axis.

As shown in FIG. 4A, the misalignment of the pupil relay module according to the yaw rotation translates in an output angular field of view 410 of the pupil relay module being shifted from an input angular field of view 210 of the objective. As illustrated in FIG. 4B and detailed herein above, the presently disclosed method may include assessing an image sharpness in the sagittal direction (i.e. for light rays in a sagittal plane of the objective) at several locations in the field of view of the objective. This may be achieved by positioning edge targets 610, 630, 650 at said different locations within the field of view of the objective. The edge targets may be imaged such that a transition between light and dark occurs perpendicular to the sagittal direction. Imaging areas 610b, 630b and 650b illustrate areas such that the transition occurs perpendicular to the sagittal direction. Further, the edge targets 610, 630, 650 may be positioned horizontally (i.e. such as to scan the field of view in a direction perpendicular to the sagittal direction). As illustrated, two or more locations within the field of view may be imaged such as to easily detect a variation over the field of view of a working distance corresponding to a sharpest image. Advantageously, a contrast target may be positioned in the center of the field of view.

For each working distance, the image of the edge targets 610, 630, 650 over imaging areas 610b, 630b, 650b may be analyzed to determine an edge spread function (ESF) and a sagittal MTF (MTFS) over said respective image areas. The MTFS may be averaged over relevant spatial frequencies.

The resulting MTFS corresponding to a target may provide an assessment of image sharpness for various working distances, enabling to determine a working distance for a sharpest image. By comparing the working distances of the sharpest image for said several locations (i.e. said several targets) over the field of view, it is possible to detect a remaining field curvature aberration resulting from the optical combination of the pupil relay module and objective. This is because in the absence of field curvature aberration, the working distance for the sharpest image at different location in the field of view should be the same. Furthermore, an adjustment to act on the remaining aberration detected by the assessment of the image sharpness in the sagittal direction may be performed by modifying the yaw rotation angle of the pupil relay module.

In some embodiments, reaching the predetermined combined aberration indicator target may comprise reaching an alignment position in which the sharpest images along the sagittal direction (as may be indicated by the MFTS peaks) and/or the sharpest images along the tangential direction (as may be indicated by the MTFT peaks) for said several locations in the field (e.g. respectively at FOV sagittal edges and FOV tangential edges) occur for working distances as close as possible to each other. The method may include in a first part, reaching an alignment position in which the sharpest images along the sagittal direction (as may be indicated by the MFTS peaks) for said several locations in the field (e.g. respectively at FOV sagittal edges) are as close as possible. In a second part, the method may comprise reaching an alignment position in which the sharpest images along the tangential direction (as may be indicated by the MTFT peaks) for said several locations in the field (e.g. at tangential edges) occur for working distances as close as possible to each other. This may mean that the residual field curvature aberration is minimal for sagittal and tangential rays. In other words, reaching the predetermined combined aberration indicator target may comprise reaching a point where no further improvement can be achieved.

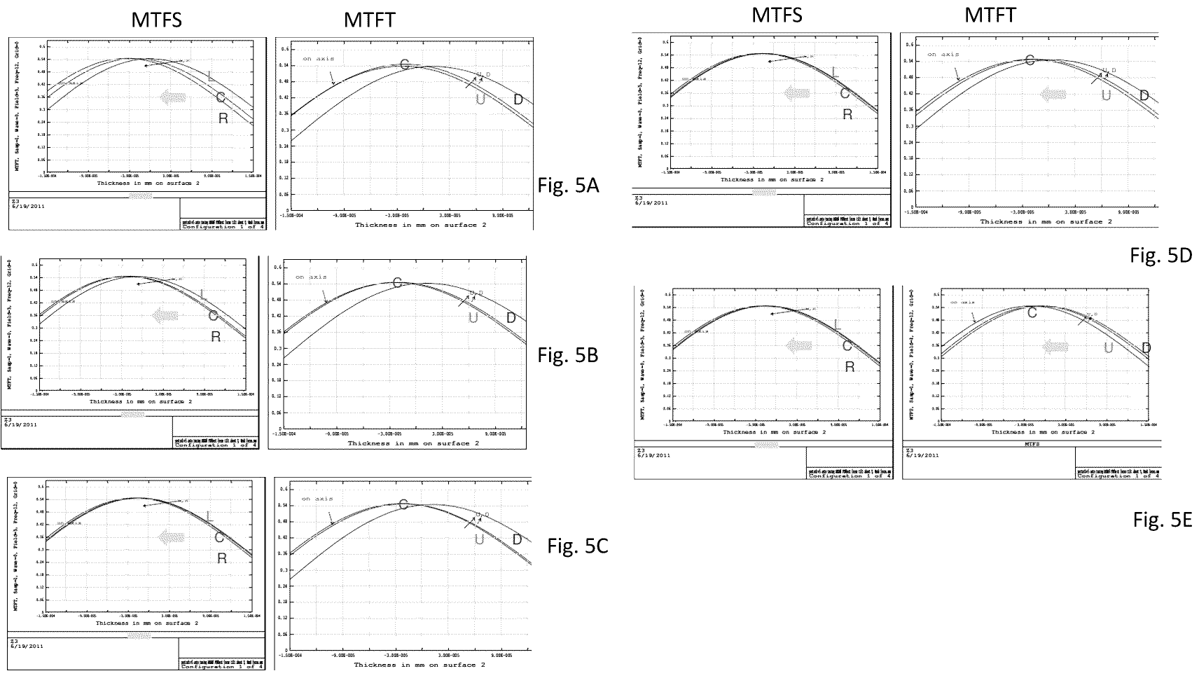

FIG. 5A-5E illustrate simulation results of a method for aligning an objective and a pupil relay module according to embodiments of the present disclosure.

In particular, FIGS. 5A-5E illustrate a modulation transfer function for sagittal rays (MTFS) and for tangential rays (MTFT) for various working distances of the contrast targets described above for a set of different yaw and pitch angles of the pupil relay module relative to the objective.

Line L corresponds to the MTFS on imaging area 610b of target 610, Line R corresponds to the MTFS on imaging area 650b of target 650, Line C in the MTFS graphs corresponds to the MTFS on imaging area 630b of target 630.

Line U corresponds to the MTFT on imaging area 620a of target 620, Line D corresponds to the MTFT on imaging area 640a of target 640, Line C in the MTFT graphs corresponds to the MTFT on imaging area 630a of target 630.

FIG. 5A-5E respectively show the MTFS (left graph) and MTFT (right graph) corresponding to the following pitch, yaw (θₓ,θ_{y}) angles: (0.016°, 0.008°); (0.008°, 0.008°); (0.0010, 0.008°); (0.0010, 0.004°); (0.0010, 0.0010).

As such, those skilled in the art to which the present invention pertains, can appreciate that while the present invention has been described in terms of preferred embodiments, the concept upon which this disclosure is based may readily be utilized as a basis for the designing of other structures, systems and processes for carrying out the several purposes of the present invention.

It will also be understood that the system according to the present disclosure may be, at least partly, implemented on a suitably programmed computer. Likewise, the present disclosure contemplates a computer program being readable by a computer for executing the method of the invention. The present disclosure further contemplates a non-transitory computer-readable memory tangibly embodying a program of instructions executable by the computer for executing the method of the present disclosure.

It is important, therefore, that the scope of the invention is not construed as being limited by the illustrative embodiments set forth herein. Other variations are possible within the scope of the present invention as defined in the appended claims. Other combinations and sub-combinations of features, functions, elements and/or properties may be claimed through amendment of the present claims or presentation of new claims in this or a related application. Such amended or new claims, whether they are directed to different combinations or directed to the same combinations, whether different, broader, narrower or equal in scope to the original claims, are also regarded as included within the subject matter of the present description.

1. A method for aligning an objective and a pupil relay module of a microscope in a semiconductor inspection tool, the objective being configured to introduce an objective aberration component consisting substantially of field curvature and the pupil relay module being configured to have a pupil relay module aberration component such that the pupil relay module aberration component compensates said objective aberration component when the pupil relay module is accurately aligned with the objective, the method comprising:
(a) measuring a combined aberration indicator indicative of a combined aberration resulting from the optical combination of the objective and pupil relay module by assessing an image sharpness along a tangential direction and along a sagittal direction at several locations in a field of view of the objective for various working distances;
(b) adjusting an optical alignment of the objective and pupil relay module based on the measured combined aberration indicator by:
i) adjusting the pupil relay module according to a yaw rotation of the pupil relay module in relation to the objective when obtaining a sharpest image along the sagittal direction at different working distances of the target for the several locations in the field of view; and
ii) adjusting the pupil relay module according to a pitch rotation of the pupil relay module in relation to the objective when obtaining a sharpest image along the tangential direction at different working distances of the target for the several locations in the field of view;
(c) iterating (a) and (b) until the measured combined aberration indicator reaching a predetermined indicator target thereby achieving accurate alignment.

2. The method according to claim 1, further comprising a preliminary step of performing a coarse alignment of the microscope objective with the pupil relay module using an optical jig.

3. The method according to claim 2, wherein the coarse alignment includes a movement along three translation axes of the objective in relation to the pupil relay module with a precision of about 10 to 50 micrometers.

4. The method according to claim 3, wherein the coarse alignment includes a pitch rotation and a yaw rotation (θₓ, θ_{y}) of the pupil relay module in relation to the objective with a precision of about 10 to 50 microradians.

5. The method according to claim 1, wherein reaching the predetermined indicator target comprises a residual combined aberration of the objective and pupil relay module being smaller than a predetermined threshold.

6. The method according to claim 5, wherein the predetermined threshold is smaller than 25 ma.

7. An optical system for a microscope comprising:
(a) an objective;
(b) a pupil relay module configured to cooperate with the objective in a folded configuration to relay an image of a sample on a microscope detector, wherein the pupil relay module is configured to be movable with respect to the objective according to six degrees of freedom for aligning the pupil relay module with the objective;
wherein the objective is configured to introduce an objective aberration component and the pupil relay module is configured to have a pupil relay module aberration component such that the pupil relay module aberration component compensates said objective aberration component when the pupil relay module is aligned to the objective, wherein the objective aberration component and the pupil relay module aberration component are adapted to allow using a null alignment technique.

8. The optical system of claim 7, wherein said objective aberration component and said pupil relay module aberration component are of a single aberration type and the objective and pupil relay module are configured to minimize optical aberrations expect for said aberration type.

9. The optical system of claim 8, wherein said aberration type is field curvature.

10. The optical system according to claim 7, wherein the objective aberration component is in a range amount of 250 to 5000 mλ.

11. The optical system according to claim 7, wherein the objective aberration component is in a range amount of about 1000 to 3000 mλ.

12. A microscope for semiconductor inspection including an optical system according to claim 7.

13. A method for aligning an objective and a pupil relay module of a microscope, the objective being configured to introduce an objective aberration component and the pupil relay module being configured to have a pupil relay module aberration component such that the pupil relay module aberration component compensates said objective aberration component when the pupil relay module is accurately aligned with the objective, the method comprising:
(a) measuring a combined aberration indicator indicative of a combined aberration resulting from the optical combination of the objective and pupil relay module;
(b) adjusting an optical alignment of the objective and pupil relay module based on the measured combined aberration indicator;
(c) iterating (a) and (b) until the measured combined aberration indicator reaches a predetermined combined aberration indicator target thereby achieving accurate alignment.

14. The method according to claim 1, wherein the objective aberration component substantially is of a single aberration type of a Zernike order below a predetermined aberration order threshold.

15. The method according to claim 13, wherein the objective aberration component comprises primarily of a field dependent aberration.

16. The method according to claim 13, wherein the field dependent aberration is field curvature.

17. The method according to claim 13, wherein measuring the combined aberration is performed by an imaging technique.

18. The method according to claim 13, wherein measuring the combined aberration is performed using a wavefront sensor.
